(19) United States
(12) Patent Application Publication
(10) Pub. No.: US 2026/0038989 A1
(43) Pub. Date: Feb. 5, 2026

(54) BUSBAR HOLDER ATTACHMENT METHOD AND BATTERY MODULE

(71) Applicant: HONDA MOTOR CO., LTD., Tokyo (JP)

(72) Inventor: Yasuhiro KAWAI, Saitama (JP)

(21) Appl. No.: 19/283,151

(22) Filed: Jul. 28, 2025

(30) Foreign Application Priority Data
Aug. 2, 2024 (JP) 2024-127664

(51) Int. Cl. H01M 50/54; H01M 50/503; H01M 50/507; H01M 50/517

(52) U.S. Cl. CPC H01M 50/54; H01M 50/503; H01M 50/507; H01M 50/517

(57) ABSTRACT

A busbar holder attachment method includes an opening step and a closing step. A portion of a busbar holder including a portion between insertion holes is provided with an open guide. A portion of each tab lead located on a base end side with respect to a tip end portion is provided with a relief portion. In the opening step, by inserting the plurality of tab leads into the corresponding insertion holes, the open guide is inserted between the tab leads to be electrically connected to each other, and tip end portions of the tab leads are opened in the X direction. In the closing step, by inserting the plurality of tab leads deeper into the insertion holes, an end portion of the open guide in the X direction is inserted into the relief portion, and the tip end portions of the tab leads are returned to a closing side.

This application is based on and claims the benefit of priority from Japanese Patent Application No. 2024-127664, filed on 2 Aug. 2024, the content of which is incorporated herein by reference.

### BACKGROUND OF THE INVENTION

### Field of the Invention

The present invention relates to a technique of attaching a busbar holder to a cell stack in which battery cells are stacked on each other.

### Related Art

In recent years, the spread of electric vehicles such as EVs and HEVs has been progressing from the perspective of reducing carbon dioxide emissions or the like and mitigating negative impact on the global environment. Some batteries mounted on the electric vehicles and the like include cell stacks in each of which a plurality of battery cells are arranged in one direction. Each battery cell includes a tab lead protruding in a direction at right angle to the one direction.

Patent Document 1: Japanese Unexamined Patent Application, Publication No. 2023-148244

### SUMMARY OF THE INVENTION

The inventor(s) of the present invention conceived of arranging a busbar between tab leads that should be electrically connected to each other in such a cell stack, in the following manner. First, a busbar holder having insertion holes into which the plurality of tab leads are to be inserted and which are formed side by side and holding a busbar between the insertion holes is prepared.

Next, the busbar holder is attached to the cell stack, and the busbar is disposed between the tab leads. Thereafter, the busbar and the tab leads adjacent thereto are clamped together. In this state, these tab leads are welded to the busbar.

However, the inventor(s) of the present invention has focused on the following problems of this technique. That is, since there is a dimension tolerance in the battery cell, the position of each battery cell with respect to the busbar holder may be misaligned from a desired position when the plurality of battery cells are stacked on each other. For this reason, upon insertion of the tab lead into the insertion hole, the tab lead may contact a portion around the insertion hole or the busbar. Thus, there is a probability that the busbar holder is not efficiently attached to the cell stack.

The present invention has been made in view of the situation above, and an object thereof is to enable efficient attachment of a busbar holder to a cell stack.

The inventor(s) of the present invention has found that the object above can be achieved when a busbar holder is provided with an open guide that opens tip end portions of tab leads in an X direction, and has arrived at the present invention. The present invention is a busbar holder attachment method according to (1) and (2) below and a battery module according to (3) below.

(1) A busbar holder attachment method is for attaching a busbar holder to a cell stack including a plurality of battery cells arranged in a predetermined X direction and the battery cells having tab leads protruding in a Y direction perpendicular to the X direction,
as viewed in an attachment state when the busbar holder will be attached to the cell stack, the busbar holder has insertion holes into which the tab leads are inserted in the Y direction and which are formed side by side in the X direction, and holds a busbar electrically connecting the tab leads between the insertion holes,
as viewed in the attachment state, a portion of the busbar holder including a portion between the insertion holes and located on the cell stack side with respect to the insertion holes in the Y direction is provided with an open guide whose width in the X direction increases as extending to the insertion hole side from the cell stack side in the Y direction, and
a portion of each tab lead located on a base end side with respect to a tip end portion is provided with a relief portion, and
the busbar holder attachment method includes
an opening step of inserting the plurality of tab leads into the corresponding insertion holes to insert the open guide between the tab leads to be electrically connected to each other and open tip end portions of the tab leads in the X direction, and
a closing step of inserting, after the opening step, the plurality of tab leads deeper into the insertion holes to insert an end portion of the open guide in the X direction into the relief portion and close the tip end portions of the tab leads to a closing side in the X direction.

According to the present configuration, in the opening step, by inserting the plurality of tab leads into the corresponding insertion holes, the open guide is inserted between the tab leads, and the tip end portions of the tab leads are opened in the X direction. Thus, the tip end portions of the tab leads can be opened in the X direction only by inserting the plurality of tab leads into the corresponding insertion holes. Consequently, contact of each tab lead with a portion of the busbar holder around the insertion hole or the like can be avoided.

Further, in the subsequent closing step, the tip end portions of the tab leads are closed by inserting the plurality of tab leads deeper into the insertion holes. Thus, the tip end portions of the tab leads can be closed only by inserting the plurality of tab leads deeper into the insertion holes.

With the configuration above, the busbar holder can be efficiently attached to the cell stack.

(2) In the busbar holder attachment method according to (1),
the relief portion includes relief portions formed in the form of a cutout recessed in a Z direction perpendicular to the X direction and the Y direction in both ends of each tab lead in the Z direction,
as viewed in the attachment state, both ends of the open guide in the Z direction are provided with protrusions protruding in the X direction, and
the protrusions are inserted into the relief portions.

According to the present configuration, the relief portion and the open guide can be simplified.

(3) A battery module includes
a cell stack including a plurality of battery cells arranged in a predetermined X direction and the battery cells having tab leads protruding in a Y direction perpendicular to the X direction, and
a busbar holder attached to the cell stack,
the busbar holder has insertion holes into which the tab leads are inserted in the Y direction and which are formed side by side in the X direction, and holds a busbar electrically connecting the tab leads between the insertion holes,
a portion of the busbar holder including a portion between the insertion holes and located on the cell stack side with respect to the insertion holes in the Y direction is provided with an open guide whose width in the X direction increases as extending to the insertion hole side from the cell stack side in the Y direction,
a portion of each tab lead located on a base end side with respect to a tip end portion is provided with a relief portion,
the plurality of tab leads are inserted into the corresponding insertion holes, and
an end portion of the open guide in the X direction is inserted into the relief portion.

The battery module with the present configuration can be manufactured by performing the method according to (1) above. Thus, effects similar to those of the case of (1) above are obtained.

As described above, according to the method according to (1) above and the battery module according to (3) above, the busbar holder can be efficiently attached to the cell stack. Further, according to the configuration (2) above citing (1) above, an additional effect is obtained.

### BRIEF DESCRIPTION OF THE DRAWINGS

FIG. 1 is an exploded sectional view of a battery module of a first embodiment as viewed in a Z direction;

FIG. 2 is a sectional view of the battery module as viewed in the Z direction;

FIG. 3 is an enlarged view of part of FIG. 1, specifically a view showing a section taken along fg3-fg3 line in FIG. 5;

FIG. 4 is an exploded perspective view showing the battery module;

FIG. 5 is a view showing a section taken along fg5-fg5 line in FIG. 3;

FIG. 6 is a view showing a section taken along fg6-fg6 line in FIGS. 3 and 5;

FIG. 7 is an enlarged view of part of FIG. 1, specifically a view showing a section taken along fg7-fg7 line in FIG. 10;

FIG. 8 is a sectional view showing an opening step in a busbar holder attachment method;

FIG. 9 is a sectional view showing a closing step in the busbar holder attachment method, specifically a view showing a section taken along fg9-fg9 line in FIG. 11;

FIG. 10 is a view showing a section taken along fg10-fg10 line in FIG. 7; and

FIG. 11 is a view showing a section taken along fg11-fg11 line in FIG. 9.

### DETAILED DESCRIPTION OF THE INVENTION

Hereinafter, embodiments of the present invention will be described with reference to the drawings. Note that the present invention is not limited to the following embodiments and changes can be made as necessary without departing from the gist of the present invention.

### First Embodiment

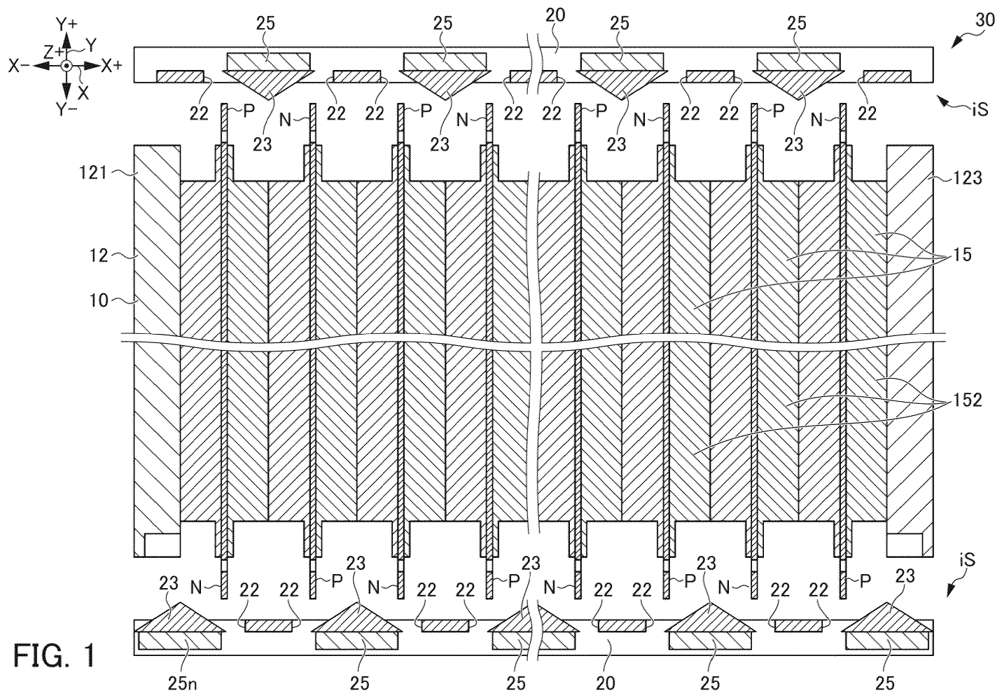

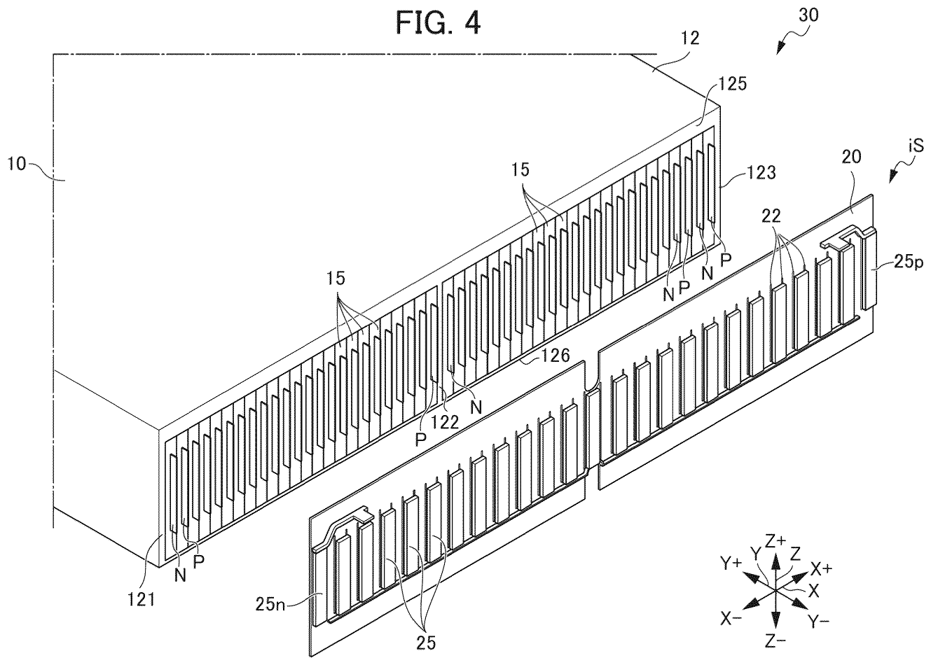

As shown in FIG. 1, a battery module 30 includes a cell stack 10 and two busbar holders 20. Hereinafter, as shown in FIG. 4, predetermined three directions perpendicular to each other with reference to the cell stack 10 will be referred to as an “X direction”, a “Y direction”, and a “Z direction”. Moreover, one side in the X direction will be referred to as an “X− side”, and the opposite side thereof will be referred to as an “X+ side”. Further, one side in the Y direction will be referred to as a “Y− side”, and the opposite side thereof will be referred to as a “Y+ side”. In addition, one side in the Z direction will be referred to as a “Z− side”, and the opposite side thereof will be referred to as a “Z+ side”.

As shown in FIG. 4, the cell stack 10 includes a housing 12 and a plurality of battery cells 15. The housing 12 includes two side plates 125, 126, two end plates 121, 123, and a center plate 122.

The two side plates 125, 126 are provided in parallel with a gap therebetween in the Z direction. Each side plate 125, 126 extends in the X direction and the Y direction. The two end plates 121, 123 connect end portions of the two side plates 125, 126 in the X direction to each other. The center plate 122 connects intermediate portions of the two side plates 125, 126 in the X direction to each other. Each end plate 121, 123 and the center plate 122 extends in the Y direction and the Z direction.

The battery cells 15 extending in the Y direction and the Z direction are stored side by side in the X direction inside the housing 12. Specifically, half of the battery cells 15 are stored between the X− side end plate 121 and the center plate 122. On the other hand, the remaining half of the battery cells 15 are stored between the center plate 122 and the X+ side end plate 123.

As shown in FIG. 1, each battery cell 15 includes a cell body 152, a Y+ side tab lead P, N protruding to the Y+ side from a Y+ side end portion of the cell body 152, and a Y− side tab lead N, P protruding to the Y-side from a Y− side end portion of the cell body 152. Each tab lead P, N is in a plate shape extending in the Y direction and the Z direction. Of each battery cell 15, one of the two tab leads P, N on both sides in the Y direction is a positive electrode side tab lead P, and the other is a negative electrode side tab lead N.

Hereinafter, arrangement of the battery cell 15 in which the positive electrode side tab lead P is disposed on the Y+ side and the negative electrode side tab lead N is disposed on the Y− side will be referred to as “positive-negative arrangement”. Moreover, arrangement of the battery cell 15 in which the negative electrode side tab lead N is disposed on the Y+ side and the positive electrode side tab lead P is disposed on the Y− side will be referred to as “negative-positive arrangement”.

In the cell stack 10, the battery cells 15 in the positive-negative arrangement and the battery cells 15 in the negative-positive arrangement are alternately arranged in the X direction. Specifically, the battery cell 15 closest to the X− side is in the positive-negative arrangement. Moreover, the battery cell 15 closest to the X+ side is in the negative-positive arrangement.

Therefore, at a Y+ side end portion of the cell stack 10 and a Y− side end portion of the cell stack 10, the positive electrode side tab leads P and the negative electrode side tab leads N are alternately arranged in the X direction.

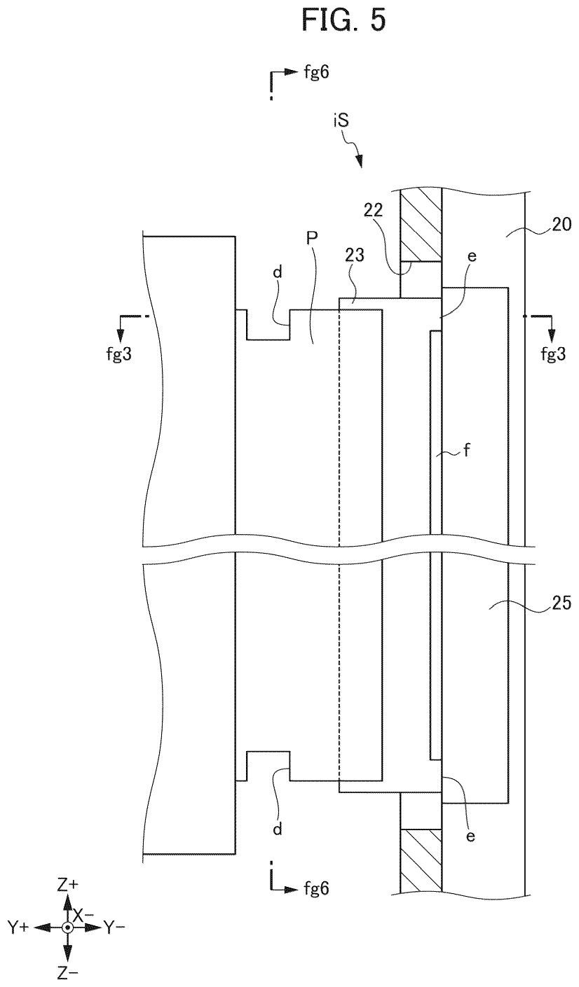

As shown in FIG. 5, a portion of a Z+ side end portion of each tab lead P, N located closer to a base end side than a tip end portion in the Y direction is provided with a relief portion d in the form of a cutout recessed to the Z− side. Moreover, a portion of a Z− side end portion of each tab lead P, N located closer to the base end side than the tip end portion in the Y direction is provided with a relief portion d in the form of a cutout recessed to the Z+ side. The function of these relief portions d will be described later.

Next, the two busbar holders 20 shown in FIG. 1 will be described. Each busbar holder 20 is provided as an insulator such as resin. One busbar holder 20 is attached to the Y+ side end portion of the cell stack 10. The other busbar holder 20 is attached to the Y− side end portion of the cell stack 10. Hereinafter, the busbar holder 20 attached to the Y+ side end portion of the cell stack 10 will be referred to as a “Y+ side busbar holder 20”. Moreover, the busbar holder 20 attached to the Y− side end portion of the cell stack 10 will be referred to as a “Y− side busbar holder 20”.

Hereinafter, a state when the busbar holders 20 will be attached to the cell stack 10 will be referred to as an “attachment state iS”. As viewed in the attachment state iS, the Y− side busbar holder 20 is configured as follows.

As shown in FIG. 4, the Y− side busbar holder 20 extends in the X direction and the Z direction. In the busbar holder 20, insertion holes 22 extending in the Z direction are formed side by side at intervals in the X direction.

A portion of the Y− side surface of the Y− side busbar holder 20 located on the X− side with respect to the insertion hole 22 closest to the X− side holds a negative electrode busbar 25n. The negative electrode busbar 25n is a conductor for connecting the negative electrode side tab lead N in the battery cell 15 closest to the negative electrode side to a negative electrode terminal of the entire battery module 30. The negative electrode busbar 25n extends in the Z direction, and extends from a Z+ side end portion to the X+ side.

A coupling busbar 25 for electrically connecting the tab leads P, N to each other is held between each even-numbered insertion hole 22 from the X− side and the insertion hole 22 adjacent to such an insertion hole 22 on the X+ side on the Y− side surface of the Y− side busbar holder 20. Each of these coupling busbars 25 is a conductor for electrically connecting the positive electrode side tab lead P and the negative electrode side tab lead N adjacent thereto on the X+ side, and extends in the Z direction.

A portion of the Y− side surface of the Y− side busbar holder 20 located on the X+ side with respect to the insertion hole 22 closest to the X+ side holds a positive electrode busbar 25p. The positive electrode busbar 25p is a conductor for connecting the positive electrode side tab lead P in the battery cell 15 closest to the positive electrode side to a positive electrode terminal of the entire battery module 30. The positive electrode busbar 25p extends in the Z direction, and extends from a Z+ side end portion to the X− side.

Each of these busbars 25n, 25, 25p is held by the busbar holder 20, for example, by fitting a protrusion provided on the busbar holder 20 side in a hole or a recess provided on the busbar 25n, 25, 25p side.

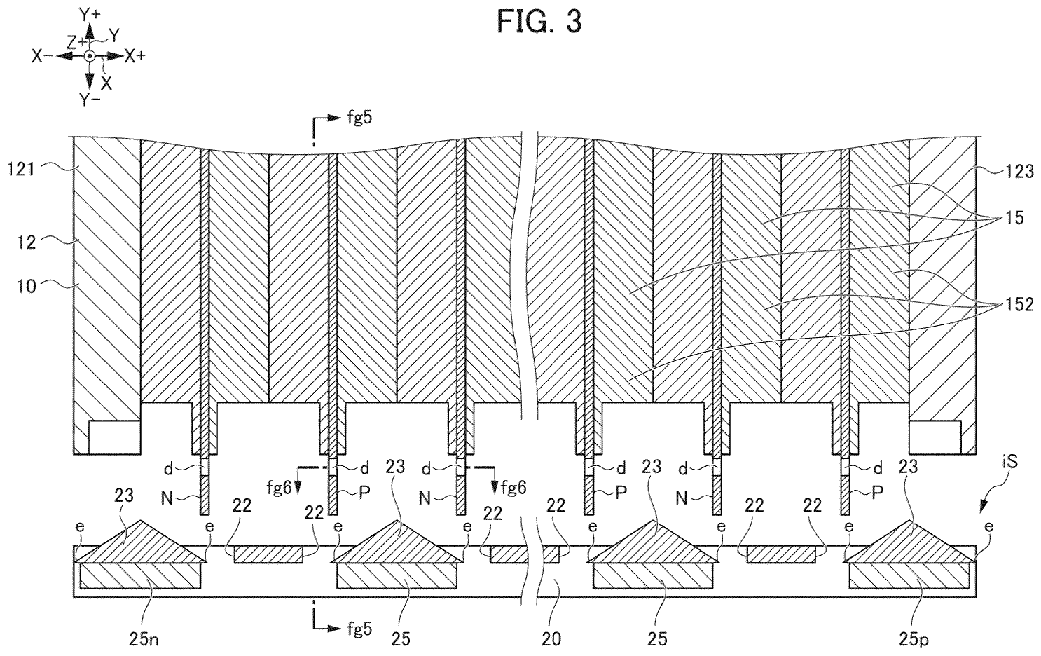

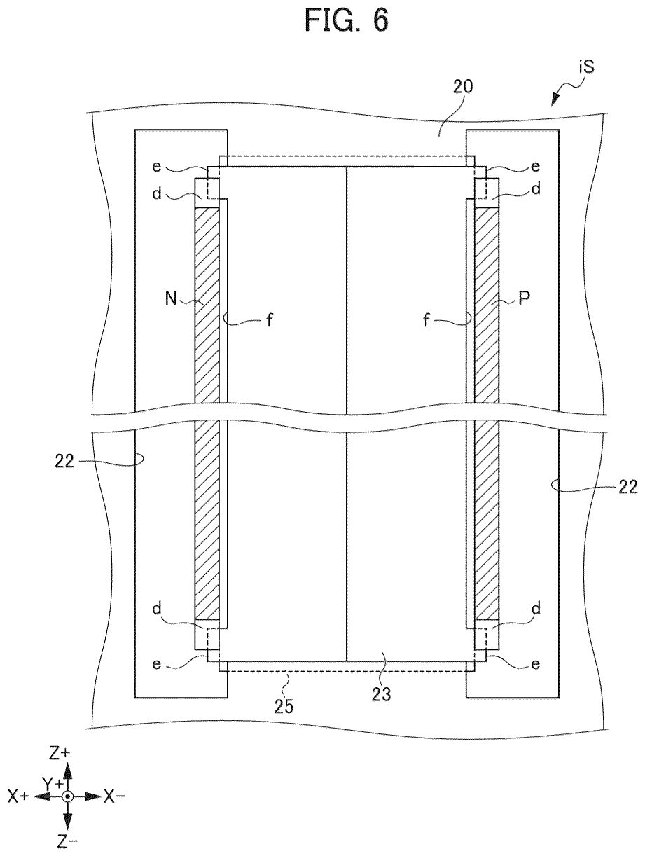

As shown in FIG. 3, a portion of the Y+ side surface of the Y− side busbar holder 20 located on the Y+ side of each busbar 25n, 25, 25p is provided with an open guide 23 whose width in the X direction increases as extending to the Y− side. Specifically, in the present embodiment, each open guide 23 is in a triangular shape as viewed in the Z direction, but may be in a shape other than the triangular shape. Specifically, for example, each open guide 23 may be in a trapezoidal shape obtained by removing a Y+ side tip end portion from the triangular shape. As shown in FIG. 6, intermediate portions of the open guide 23 in the Z direction at both end portions thereof in the X direction are provided with groove-shaped cutouts f recessed in the X direction and extending in the Z direction. Thus, protrusions e protruding in the X direction are formed at both end portions of the open guide 23 in the Z direction at both end portions thereof in the X direction.

The description above is description in a case where the Y− side busbar holder 20 is viewed in the attachment state iS.

Next, the Y+ side busbar holder 20 shown in FIG. 1 will be described. The description of the Y+ side busbar holder 20 is substantially similar to the description of the Y− side busbar holder 20 above, except for the following points. That is, “FIG. 3” and “FIG. 4” are replaced with “FIG. 1”. Moreover, the “Y− side” and the “Y+ side” are replaced with each other, and “even-numbered” is replaced with “odd-numbered”. Further, the description of the negative electrode busbar 25n and the positive electrode busbar 25p will be omitted. That is, the Y+ side busbar holder 20 does not hold the negative electrode busbar 25n and the positive electrode busbar 25p, and only holds the plurality of coupling busbars 25.

Next, a Y+ side bus bur holder attachment method for attaching the Y+ side busbar holder 20 to the Y+ side end portion of the cell stack 10 will be described. Note that the Y+ side bus bur holder attachment method may be manually performed by a worker or the like, or may be automatically performed by a machine or the like.

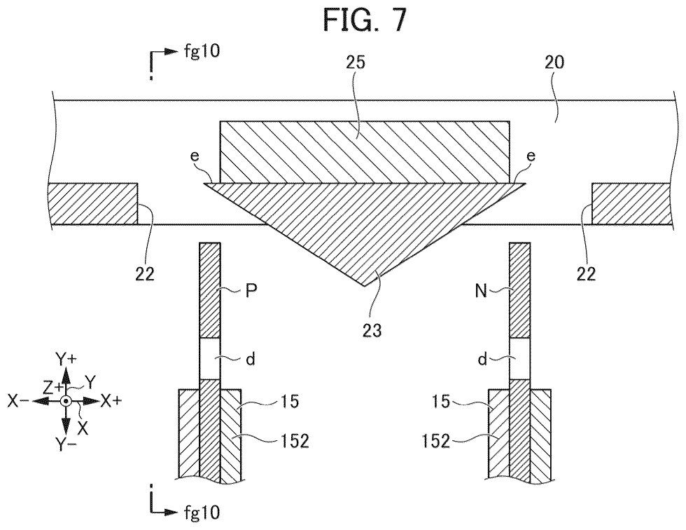

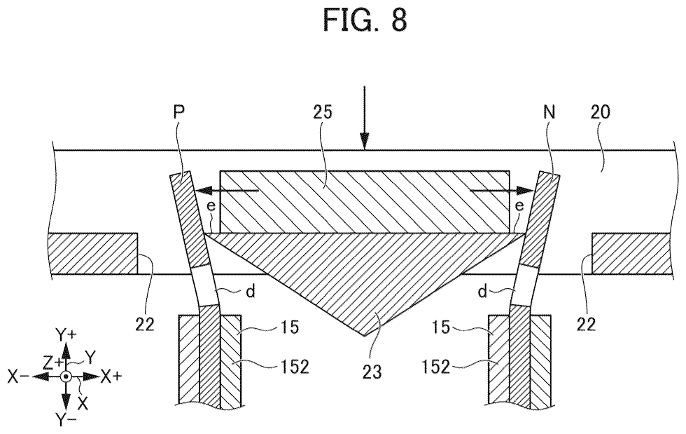

In the Y+ side bus bur holder attachment method, a predetermined opening step is first performed. In this opening step, the Y+ side busbar holder 20 shown in FIG. 7 is moved from a position more to the Y+ side than each Y+ side tab lead P, N toward the Y− side as shown in FIG. 8. By such movement, the tip end of each tab lead P, N contacts the open guide 23 and is guided by a guide surface (inclined surface) thereof, and each tab lead P, N is then inserted into the corresponding insertion hole 22. Accordingly, the open guide 23 is inserted between the tab leads P, N to be electrically connected to each other. By the open guide 23, the tip end portions of the tab leads P, N are opened in the X direction.

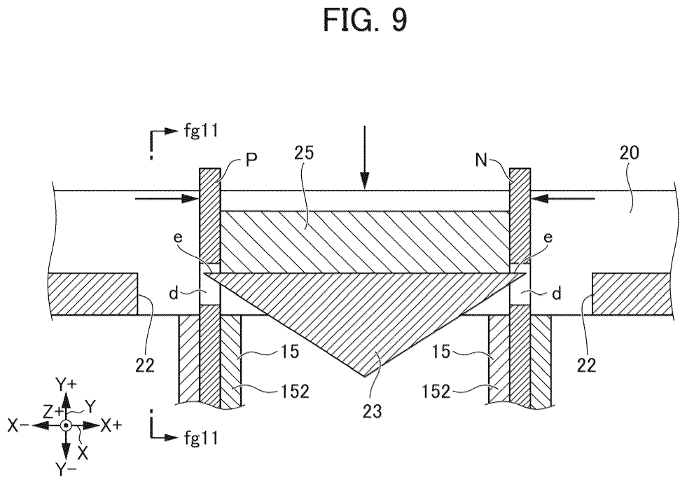

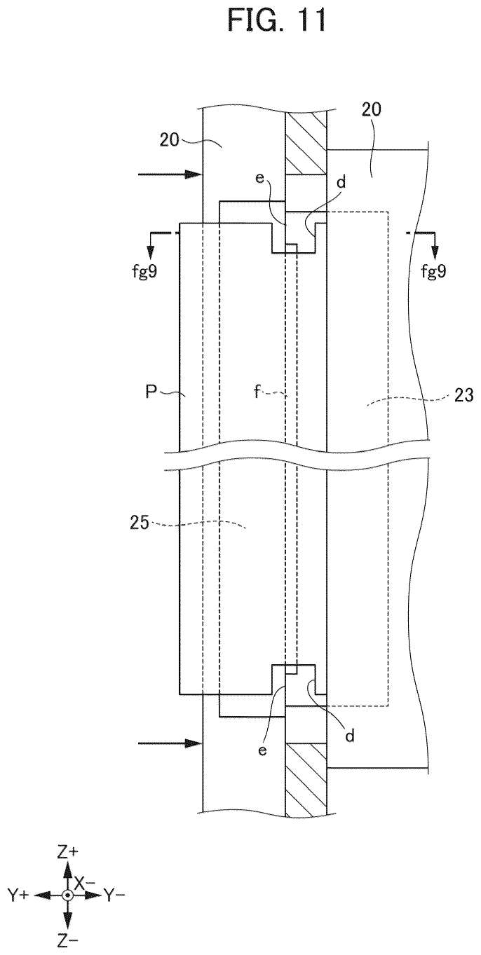

From this state, a predetermined closing step is performed. In this closing step, the Y+ side busbar holder 20 shown in FIG. 8 is further moved to the Y− side as shown in FIG. 9. Accordingly, each tab lead P, N is inserted deeper into the insertion hole 22. Accordingly, as shown in FIG. 11, the protrusions e at both end portions of the open guide 23 in the Z direction at both end portions thereof in the X direction are each inserted into the corresponding relief portions d.

From this state, each tab lead P, N shown in FIG. 9 is welded to the busbar 25 close thereto. Note that in a case where each tab lead P, N will have sufficiently stable electrical connection to the busbar 25 close thereto without such welding, the welding may be omitted. Alternatively, instead of or in addition to the welding, the tip end portion of each tab lead P, N may be bent to ensure electrical connection between this tab lead P, N and the busbar 25 close thereto.

Next, a Y− side busbar holder attachment method for attaching the Y− side busbar holder 20 to the Y− side end portion of the cell stack 10 shown in FIG. 1 will be described. The description of the Y− side busbar holder attachment method is substantially similar to the description of the Y+ side busbar holder attachment method described above, except for the following points. That is, the description of the drawings to be referred will be omitted, and the “Y− side” and the “Y+ side” are replaced with each other.

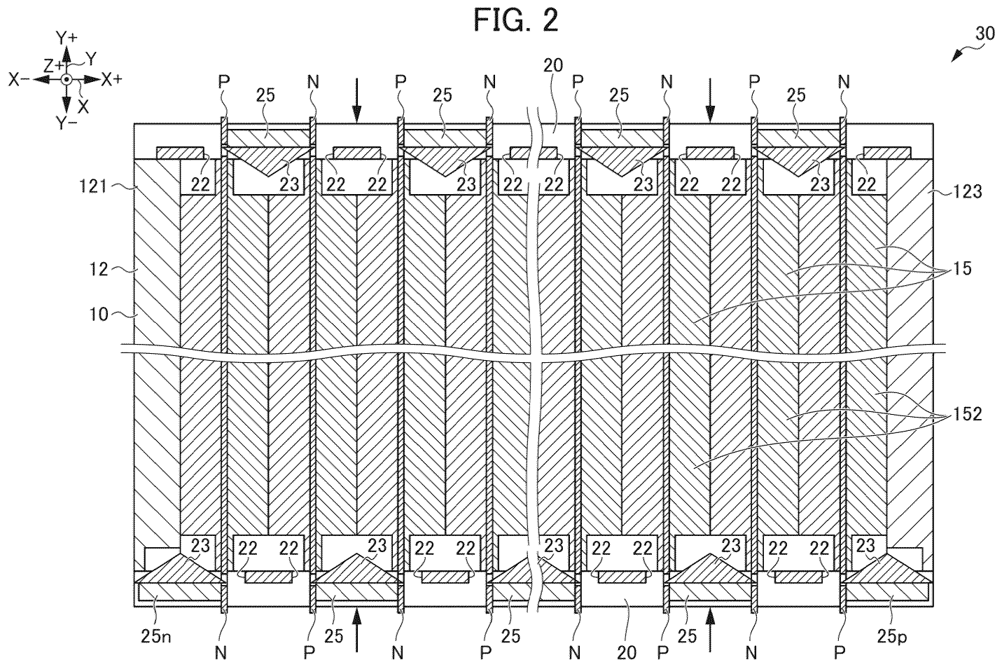

Next, the battery module 30 manufactured by the above-described Y+ side and Y− side busbar holder attachment methods will be described. In the completed state of the battery module 30 shown in FIG. 2, each tab lead P, N is inserted deep into the corresponding insertion hole 22. Thus, as shown in FIG. 9, each protrusion e of the open guide 23 is inserted into the relief portion d.

Hereinafter, the configuration and effects of the present embodiment will be summarized.

As shown in FIG. 8, in the opening step, the open guide 23 is inserted between the tab leads P, N by inserting each tab lead P, N into the corresponding insertion hole 22. By the open guide 23, the tip end portions of the tab leads P, N are opened in the X direction. Thus, the tip end portions of the tab leads P, N can be opened in the X direction only by inserting each tab lead P, N into the corresponding insertion hole 22. Thus, contact of each tab lead P, N with a portion of the busbar holder 20 around the insertion hole 22 or the like can be avoided.

Further, in the subsequent closing step, as shown in FIG. 9, the protrusions e are inserted into the relief portions d by inserting each tab lead P, N deeper into the insertion hole 22, and the tip end portions of the tab leads P, N are returned to a closing side. Thus, the tip end portions of the tab leads P, N can be returned to a closing side only by inserting each tab lead P, N deeper into the insertion hole 22.

With the configuration above, the busbar holders 20 can be efficiently attached to the cell stack 10.

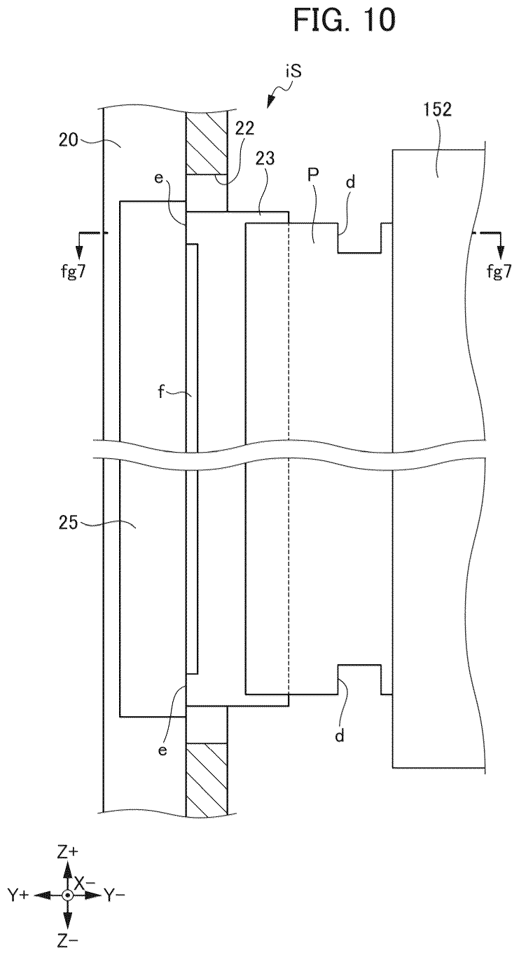

As shown in FIG. 10, both end portions of the tab lead P, N in the Z direction are provided with the relief portions d in the form of the cutout recessed in the Z direction. As viewed in the attachment state iS, both end portions of the open guide 23 in the Z direction at both end portions thereof in the X direction are provided with the protrusions e protruding in the X direction. As shown in FIG. 11, these protrusions e are each inserted into the corresponding relief portions d. Thus, the relief portion d and the open guide 23 can be simplified.

In the battery module 30 in the completed state as shown in FIG. 2, each tab lead P, N is inserted into the corresponding insertion hole 22. Moreover, as shown in FIG. 9, the protrusions e of the open guide 23 are inserted into the relief portions d. Thus, by performing the busbar holder attachment method of the present embodiment, the battery module 30 shown in FIG. 2 can be manufactured.

### Other Embodiments

The embodiments above can be changed as follows, for example. The protrusions e shown in FIG. 5 may be provided at intermediate portions in the Z direction instead of both end portions of the open guide 23 in the Z direction at both end portions thereof in the X direction. The relief portions d may be provided in the form of a through-hole in an intermediate portion of the tab lead P, N in the Z direction.

### EXPLANATION OF REFERENCE NUMERALS

10 Cell stack
15 Battery cell
20 Busbar holder
22 Insertion hole
23 Open guide
25 Busbar
30 Battery module
d Clearance
e Protrusion
iS Attachment state
N Negative electrode side tab lead
P Positive electrode side tab lead

What is claimed is:

1. A busbar holder attachment method for attaching a busbar holder to a cell stack including a plurality of battery cells arranged in a predetermined X direction and the battery cells having tab leads protruding in a Y direction perpendicular to the X direction,
as viewed in an attachment state when the busbar holder will be attached to the cell stack, the busbar holder having insertion holes into which the tab leads are inserted in the Y direction and which are formed side by side in the X direction and holding a busbar electrically connecting the tab leads between the insertion holes,
as viewed in the attachment state, a portion of the busbar holder including a portion between the insertion holes and located on a cell stack side with respect to the insertion holes in the Y direction being provided with an open guide whose width in the X direction increases as extending to an insertion hole side from the cell stack side in the Y direction, and
a portion of each tab lead located on a base end side with respect to a tip end portion being provided with a relief portion,
the busbar holder attachment method comprising:
an opening step of inserting the plurality of tab leads into the corresponding insertion holes to insert the open guide between the tab leads to be electrically connected to each other and open tip end portions of the tab leads in the X direction; and
a closing step of inserting, after the opening step, the plurality of tab leads deeper into the insertion holes to insert an end portion of the open guide in the X direction into the relief portion and return the tip end portions of the tab leads to a closing side in the X direction.

2. The busbar holder attachment method according to claim 1, wherein
the relief portion includes relief portions formed in a form of a cutout recessed in a Z direction perpendicular to the X direction and the Y direction in both ends of each tab lead in the Z direction,
as viewed in the attachment state, both ends of the open guide in the Z direction are provided with protrusions protruding in the X direction, and
the protrusions are inserted into the relief portions.

3. A battery module comprising:
a cell stack including a plurality of battery cells arranged in a predetermined X direction and the battery cells having tab leads protruding in a Y direction perpendicular to the X direction; and
a busbar holder attached to the cell stack,
wherein the busbar holder has insertion holes into which the tab leads are inserted in the Y direction and which are formed side by side in the X direction, and holds a busbar electrically connecting the tab leads between the insertion holes,
a portion of the busbar holder including a portion between the insertion holes and located on a cell stack side with respect to the insertion holes in the Y direction is provided with an open guide whose width in the X direction increases as extending to an insertion hole side from the cell stack side in the Y direction,
a portion of each tab lead located on a base end side with respect to a tip end portion is provided with a relief portion,
the plurality of tab leads are inserted into the corresponding insertion holes, and
an end portion of the open guide in the X direction is inserted into the relief portion.
